(19) United States
(12) Patent Application Publication
(10) Pub. No.: US 2021/0300242 A1
(43) Pub. Date: Sep. 30, 2021

(54) VEHICLE APPROACH NOTIFICATION SYSTEM, VEHICLE, AND VEHICLE APPROACH NOTIFICATION METHOD

(71) Applicant: Panasonic Intellectual Property Management Co., Ltd., Osaka (JP)

(72) Inventor: Fumiyasu KONNO, Osaka (JP)

(73) Assignee: Panasonic Intellectual Property Management Co., Ltd., Osaka (JP)

(21) Appl. No.: 17/205,577

(22) Filed: Mar. 18, 2021

(30) Foreign Application Priority Data
Mar. 26, 2020 (JP) 2020-055537

(51) Int. Cl. B60Q 5/00; B60R 11/02; H04R 3/12; H04R 5/04; H04R 5/02

(52) U.S. Cl. CPC B60Q 5/008; B60R 11/0217; H04R 2499/13; H04R 5/04; H04R 5/02; H04R 3/12

(57) ABSTRACT

A vehicle approach notification system for notifying approach of a vehicle includes: a first speaker and a second speaker provided in a speaker case included in a vehicle; a sound source that outputs sound signals which are respectively input to the first speaker and the second speaker and correspond to a sound notifying the approach of the vehicle; and a phase controller that controls a phase of at least one sound signal out of the sound signal input to the first speaker and the sound signal input to the second speaker so that sound pressure at left and right of the vehicle caused by the sound output from the first speaker and the second speaker is higher than sound pressure along a longitudinal axis of the vehicle caused by the sound output from the first speaker and the second speaker.

### CROSS REFERENCE TO RELATED APPLICATION

The present application is based on and claims priority of Japanese Patent Application No. 2020-055537 filed on Mar. 26, 2020.

### FIELD

The present disclosure relates to a vehicle approach notification system for notifying approach of a vehicle, a vehicle equipped with the vehicle approach notification system, and a vehicle approach notification method.

### BACKGROUND

Because of their noiselessness, electric vehicles and hybrid vehicles have a problem of nearby people such as pedestrians being less likely to be aware of approach of the vehicle while it is running at a low speed, in which case road noises of the vehicle of its own are small. Accordingly, noiseless vehicles such as electric vehicles and hybrid vehicles are provided with a device for warning nearby people such as pedestrians of approach of the vehicle by outputting a sound (also referred to as “notification sound”) for an alert to how fast the vehicle is running (for example, Patent Literature 1 (PTL 1)).

### CITATION LIST

### Patent Literature

PTL 1: International Publication No. 2012/023170

### SUMMARY

However, the technique disclosed in PTL 1 can be improved upon.

In view of this, the present disclosure provides a vehicle approach notification system, and so on, capable of improving upon the above-described related art.

A vehicle approach notification system according to an aspect of the present disclosure is a vehicle approach notification system for notifying approach of a vehicle, and includes: a first speaker and a second speaker provided in a speaker case included in a vehicle; a sound source that outputs sound signals which are respectively input to the first speaker and the second speaker and correspond to a sound notifying the approach of the vehicle; and a phase controller that controls a phase of at least one sound signal out of the sound signal input to the first speaker and the sound signal input to the second speaker so that sound pressure at left and right of the vehicle caused by the sounds output from the first speaker and the second speaker is higher than sound pressure along a longitudinal axis of the vehicle caused by the sounds output from the first speaker and the second speaker.

A vehicle according to an aspect of the present disclosure includes the above-described vehicle approach notification system.

A vehicle approach notification method according to an aspect of the present disclosure is a vehicle approach notification method for notifying approach of a vehicle, and includes: outputting sound signals which are respectively input to a first speaker and a second speaker provided in a speaker case included in a vehicle, the sound signals corresponding to a sound notifying the approach of the vehicle; and controlling a phase of at least one sound signal out of the sound signal input to the first speaker and the sound signal input to the second speaker so that sound pressure at left and right of the vehicle caused by the sounds output from the first speaker and the second speaker is higher than sound pressure along a longitudinal axis of the vehicle caused by the sounds output from the first speaker and the second speaker.

It should be noted that these generic or specific aspects may be implemented as a system, a method, an integrated circuit, a computer program, or a computer-readable recording medium such as a CD-ROM, or may be implemented as any combination of a system, a method, an integrated circuit, a computer program, or a recording medium.

A vehicle approach notification system, and so on, according to an aspect of the present disclosure are capable of improving upon the above-described related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a graph illustrating frequency characteristics of a sound pressure of a sound output from one speaker.

FIG. 2 illustrates an example of a vehicle equipped with a speaker system including a first speaker and a second speaker that are disposed back-to-back in a vehicle approach notification system according to an embodiment.

FIG. 3 is a block diagram illustrating a configuration of the vehicle approach notification system according to the embodiment.

FIG. 4 illustrates a positional relationship between the speaker system and microphones.

FIG. 5 is a graph illustrating frequency characteristics of sound pressures of sounds output from the first speaker and the second speaker disposed back-to-back.

FIG. 6 illustrates an example of a vehicle equipped with a speaker system including the first speaker, the baffle face of which is oriented to the front left of the vehicle, and the second speaker, the baffle face of which is oriented to the front right of the vehicle, in the vehicle approach notification system according to the embodiment.

FIG. 7 is a graph illustrating frequency characteristics of sound pressures of sounds output from the first speaker, the baffle face of which is oriented to the front left of the vehicle, and the second speaker, the baffle face of which is oriented to the front right of the vehicle.

FIG. 8 illustrates an example of a vehicle equipped with a speaker system including the first speaker, the baffle face of which is oriented to the front right of the vehicle, and the second speaker, the baffle face of which is oriented to the front left of the vehicle, in the vehicle approach notification system according to the embodiment.

FIG. 9 is a graph illustrating frequency characteristics of sound pressures of sounds output from the first speaker, the baffle face of which is oriented to the front right of the vehicle, and the second speaker, the baffle face of which is oriented to the front left of the vehicle.

FIG. 10 illustrates an example of a vehicle equipped with a speaker system including the first speaker and the second speaker, both of which have their baffle faces oriented forward the vehicle, in the vehicle approach notification system according to the embodiment.

FIG. 11 is a graph illustrating frequency characteristics of sound pressures of sounds output from the first speaker and the second speaker, both of which have their baffle faces oriented forward the vehicle.

FIG. 12 is a flowchart illustrating an example of a vehicle approach notification method according to another embodiment.

### DESCRIPTION OF EMBODIMENTS

### (Underlying Knowledge Forming the Basis of the Present Disclosure)

For the notification sound to be output from noiseless vehicles such as electric vehicles and hybrid vehicles, studies are under way to define minimum sound pressure values in the regulation of North America NHTSA (National Highway Traffic Safety Administration). For example, the minimum sound pressure values are defined for 8 frequency bands of ⅓ octave, and it is required to output a notification sound that is of equal to or larger than the minimum sound pressure values as measured in a predetermined measurement method. For example, while a vehicle is running, two microphones are used to measure sound pressures of the notification sound when the vehicle passes between the two microphones, and it is required that the sound pressures of the notification sound are equal to or larger than the minimum sound pressure values to the left and right of the vehicle.

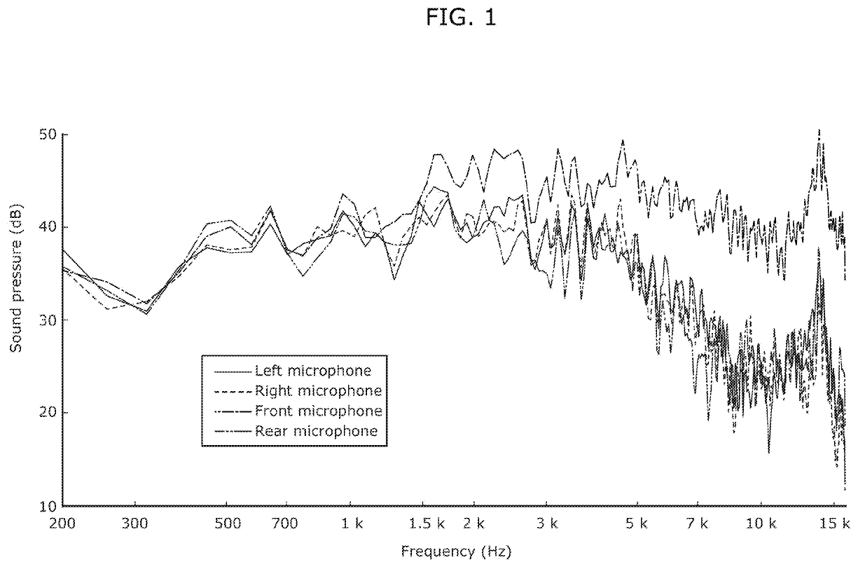

FIG. 1 is a graph illustrating frequency characteristics of sound pressures of sounds output from one speaker. In FIG. 1, a solid line indicates frequency characteristics of a sound pressure of a sound collected by a microphone disposed at 1 m away from the speaker to the left, a dashed line indicates frequency characteristics of a sound pressure of a sound collected by a microphone disposed at 1 m away from the speaker to the right, a long dashed short-dashed line indicates frequency characteristics of a sound pressure of a sound collected by a microphone disposed at 1 m forward from the speaker, and a long dashed double-short-dashed line indicates frequency characteristics of a sound pressure of a sound collected from a microphone disposed at 1 m backward from the speaker.

For example, it is assumed that the notification sound is output from a speaker disposed in a hood portion of a vehicle, and a place where a microphone behind the speaker is located corresponds to the inside of a vehicle cabin. Microphones in front, to the left, and to the right of the speaker correspond to the front, left, and right of the vehicle, respectively. To reduce uncomfortableness to passengers in the vehicle cabin caused by the notification sound intruding into the vehicle cabin, the sound pressure of the sound collected by the microphone behind the speaker needs to be low. On the other hand, to effectively output the notification sound to the outside of the vehicle while it is running, the sound pressures of the sounds collected by microphones located to the left and right of the speaker needs to be high.

In FIG. 1, since a baffle face of the speaker faces to the side of a front microphone, for example, the sound pressure (corresponding to the sound pressure in front of the vehicle) of the sound collected by the microphone in front of the speaker is high over a wide frequency band. On the other hand, in the case of the sound pressures (corresponding to the sound pressures to the left and right of the vehicle) of the sounds collected by the microphones located to the left and right of the speaker, these both exhibit the sound pressures as large as that of the front microphone up to approximately 1.5 kHz, while these both exhibit lower sound pressures than that of the front microphone in a frequency band higher than approximately 1.5 kHz (in particular, 5 kHz). Further, the sound pressure (corresponding to the sound pressure in the vehicle cabin) of the sound collected by the microphone behind the speaker is as large as the sound pressures of the sounds collected by the microphones to the left and right of the speaker. In other words, when the notification sound is output from one speaker, a satisfactory sound pressure may not be obtained to the left and right of the vehicle and the notification sound may leak into the vehicle cabin at a sound pressure as large as those of the notification sounds to the left and right of the vehicle. As a result, when the notification sound is output from one speaker, the notification sound may not be effectively output to the outside of the vehicle while passengers may feel uncomfortable.

Based on the knowledge as described above, the present inventors have studied a vehicle approach notification system and the like capable of effectively outputting the notification sound to the outside of the vehicle while reducing uncomfortableness to passengers.

A vehicle approach notification system according to an aspect of the present disclosure is a vehicle approach notification system for notifying approach of a vehicle, and includes: a first speaker and a second speaker provided in a speaker case included in a vehicle; a sound source that outputs sound signals which are respectively input to the first speaker and the second speaker and correspond to a sound notifying the approach of the vehicle; and a phase controller that controls a phase of at least one sound signal out of the sound signal input to the first speaker and the sound signal input to the second speaker so that sound pressure at left and right of the vehicle caused by the sounds output from the first speaker and the second speaker is higher than sound pressure along a longitudinal axis of the vehicle caused by the sounds output from the first speaker and the second speaker.

For example, it is possible to control directivity of notification sounds output from at least two speakers by providing phase difference between the sounds output from the at least two speakers. Accordingly, it is possible to control phases of sound signals input to the first speaker and the second speaker provided in a speaker case, so that sound pressures to the left and right of the vehicle can be made higher than the sound pressure along a longitudinal axis of the vehicle. In other words, while the vehicle is running, the sound pressures of the notification sounds to the left and right of the vehicle can be made higher and the sound pressure of the notification sound leaking into the vehicle cabin located along the longitudinal axis of the vehicle can be made lower. In this way, it is possible to effectively output the notification sound to the outside of the vehicle while reducing uncomfortableness to passengers.

For example, the first speaker and the second speaker may be disposed back-to-back so that a baffle face of the first speaker is oriented to the left of the vehicle and a baffle face of the second speaker is oriented to the right of the vehicle.

Accordingly, in a frequency band of approximately 300 Hz to approximately 12 kHz or less, the sound pressures of the notification sounds to the left and right of the vehicle can be made higher and the sound pressure of the notification sound leaking into the vehicle cabin can be made lower.

For example, the first speaker may be disposed closer to a left side of the vehicle than the second speaker is, and the first speaker and the second speaker may be disposed so that a baffle face of the first speaker is oriented to a front left of the vehicle and a baffle face of the second speaker is oriented to a front right of the vehicle.

Accordingly, in a frequency band of approximately 300 Hz to approximately 3 kHz or less, the sound pressures of the notification sounds to the left and right of the vehicle can be made higher and the sound pressure of the notification sound leaking into the vehicle cabin can be made lower.

For example, the first speaker may be disposed closer to a left side of the vehicle than the second speaker is, and the first speaker and the second speaker may be disposed so that a baffle face of the first speaker is oriented to a front right of the vehicle and a baffle face of the second speaker is oriented to a front left of the vehicle.

Accordingly, in a frequency band of approximately 1.5 Hz to approximately 5 kHz or less, the sound pressures of the notification sounds to the left and right of the vehicle can be made higher and the sound pressure of the notification sound leaking into the vehicle cabin can be made lower.

For example, the baffle face of the first speaker and the baffle face of the second speaker may form an angle of approximately 90 degrees.

For example, the first speaker and the second speaker may be disposed so that a baffle face of the first speaker and a baffle face of the second speaker are both oriented to a front or a back of the vehicle.

Accordingly, in a frequency band of approximately 300 Hz to approximately 3 kHz or less, the sound pressures of the notification sounds to the left and right of the vehicle can be made higher and the sound pressure of the notification sound leaking into the vehicle cabin can be made lower.

For example, the vehicle approach notification system may further include a rotator that rotates the first speaker and the second speaker.

Accordingly, the orientation of the first speaker and the second speaker can be controlled.

Furthermore, the phase controller may control the phase of the at least one signal such that a phase of the sound signal input to the first speaker and a phase of the sound signal input to the second speaker are opposite phases.

Accordingly, it is possible to provide dipole directivity (inverted V shaped directivity) of the notification sounds output from the first speaker and the second speaker such that the direction in which there is less acoustic radiation is toward the inside of the vehicle cabin.

For example, the phase controller may control the phase of the at least one sound signal according to a speed of the vehicle.

For example, as defined in the regulation according to North America NHTSA, it is required that the notification sound is of equal to or larger than a certain sound pressure values in front of the vehicle while the vehicle is stopped. However, while the vehicle is running, it is not required that the notification sound is of equal to or larger than a certain sound pressure values in front of the vehicle. Accordingly, depending on the speed of the vehicle, for example, the phase of at least one signal is prevented from changing while the vehicle is stopped. Further, depending on the speed of the vehicle, for example, the phase of the at least one signal is changed to form dipole directivity such that the direction in which there is less acoustic radiation is toward the front of the vehicle and the inside of the vehicle cabin while the vehicle is running. In this way, it is possible to output the notification sound around the vehicle including the front of the vehicle sufficiently while the vehicle is stopped, and to output the notification sound around the vehicle sufficiently except the front of the vehicle where it is not required that the notification sound is of equal to or larger than a certain sound pressure while reducing uncomfortableness to passengers due to the notification sound while the vehicle is running.

For example, no sound is output from the first speaker and the second speaker when a speed of the vehicle is at least a predetermined speed.

For example, when a certain vehicle speed is exceeded, sound generated by the vehicle such as road noises increases. Accordingly, it is not necessary to output the notification sound because nearby people such as pedestrians are more likely to be aware of approach of the vehicle without the notification sound. Accordingly, when the speed of the vehicle is equal to or larger than a predetermined speed, it is possible to reduce uncomfortableness to passengers due to the notification sound.

A vehicle according to an aspect of the present disclosure includes the above-described vehicle approach notification system.

Accordingly, a vehicle capable of effectively outputting the notification sound to the outside of the vehicle while reducing uncomfortableness to passengers can be provided.

A vehicle approach notification method according to an aspect of the present disclosure is a vehicle approach notification method for notifying approach of a vehicle, and includes: outputting sound signals which are respectively input to a first speaker and a second speaker provided in a speaker case included in a vehicle, the sound signals corresponding to a sound notifying the approach of the vehicle; and controlling a phase of at least one sound signal out of the sound signal input to the first speaker and the sound signal input to the second speaker so that sound pressure at left and right of the vehicle caused by the sounds output from the first speaker and the second speaker is higher than sound pressure along a longitudinal axis of the vehicle caused by the sounds output from the first speaker and the second speaker.

Accordingly, a vehicle approach notification method capable of effectively outputting the notification sound to the outside of the vehicle while reducing uncomfortableness to passengers can be provided.

Hereinafter, exemplary embodiments will be described in detail with reference to the Drawings.

Note that each of the following embodiments shows a generic or specific example. The numerical values, shapes, materials, structural components, the arrangement and connection of the structural components, steps, the processing order of the steps, etc. shown in the following embodiments are mere examples, and thus are not intended to limit the present disclosure.

### Embodiment

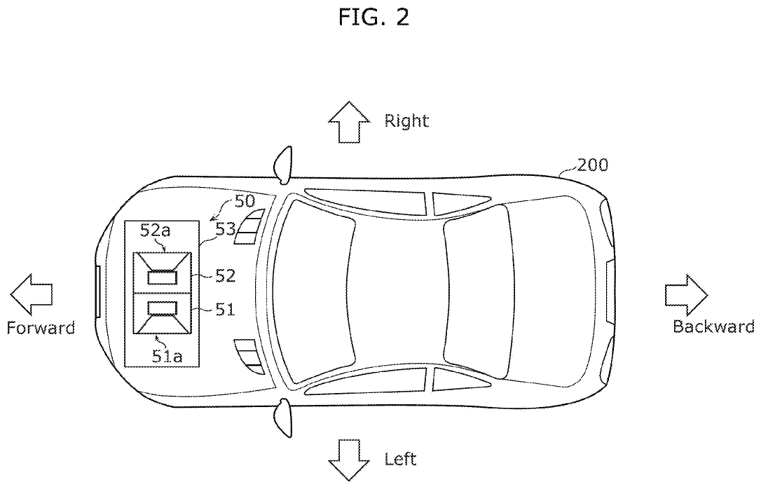

A vehicle approach notification system according to an exemplary embodiment will now be described with reference to FIGS. 2 to 11.

FIG. 2 illustrates an example of vehicle 200 equipped with speaker system 50 including first speaker 51 and second speaker 52 that are disposed back-to-back in the vehicle approach notification system according to the embodiment.

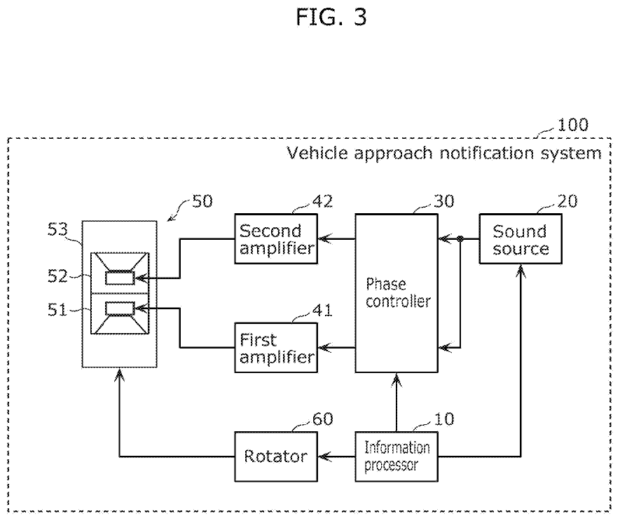

Vehicle 200 includes speaker system 50 in vehicle approach notification system 1 as described with reference to FIG. 3 hereinafter. Vehicle 200 emits notification sounds, which are output from first speaker 51 and second speaker 52, toward nearby people such as pedestrians located outside the car. For example, in an example illustrated in FIG. 2, first speaker 51 is disposed closer to a left side of vehicle 200 than second speaker 52, and first speaker 51 and second speaker 52 are disposed back-to-back with baffle face 51a of first speaker 51 being oriented to the left of vehicle 200 and baffle face 52a of second speaker 52 being oriented to the right of vehicle 200. This is illustrative only and the orientation of first speaker 51 and second speaker 52 is not limited thereto. First speaker 51 and second speaker 52 are provided in one speaker case 53. For example, speaker system 50 is installed behind a license plate in a hood portion of vehicle 200. Note that vehicle 200 may be equipped with another speaker for outputting the notification sound in addition to first speaker 51 and second speaker 52. In other words, more than three speakers for outputting the notification sound may be installed in vehicle 200.

Next, a configuration of vehicle approach notification system 100 will be described.

FIG. 3 is a block diagram illustrating a configuration of vehicle approach notification system 100 according to the embodiment.

As illustrated in FIG. 3, vehicle approach notification system 100 includes information processor 10, sound source 20, phase controller 30, first amplifier 41, second amplifier 42, speaker system 50, and rotator 60.

Vehicle approach notification system 100 is a system for notifying approach of vehicle 200 by using first speaker 51 and second speaker 52 installed in vehicle 200. Vehicle approach notification system 100 causes first speaker 51 and second speaker 52 to output notification sounds (for example, a warning sound) toward nearby people such as pedestrians located outside the car to notify them of approach of vehicle 200.

Sound source 20 outputs sound signals (electric signals) which are respectively input to first speaker 51 and second speaker 52 and correspond to a sound notifying the approach of vehicle 200. The sound notifying the approach of vehicle 200 is, for example, an engine sound. In this case, sound source 20 may use a simulated engine sound or an electric sound. Alternatively, the sound notifying the approach of vehicle 200 may be a simple sine wave signal or the like. Sound source 20 may be implemented, for example, by using a storage device, which is not illustrated. For example, when the speed of vehicle 200 is equal to or larger than a predetermined speed, it may be possible to prevent sound signals from being output from sound source 20, so that no sound is output from first speaker 51 and second speaker 52.

Phase controller 30 controls a phase of at least one sound signal out of a sound signal input to first speaker 51 (specifically, a sound signal input to first speaker 51 via first amplifier 41) and a sound signal input to second speaker 52 (specifically, a sound signal input to second speaker 52 via second amplifier 42) so that sound pressures to the left and right of vehicle 200 are higher than a sound pressure along a longitudinal axis of vehicle 200, the sound pressures being caused by sounds output from first speaker 51 and second speaker 52. Phase controller 30 is, for example, a phase shifter, and adjusts the phase of at least one sound signal out of the sound signal input to first speaker 51 and the sound signal input to second speaker 52. For example, phase controller 30 may control the phase of the at least one signal such that the phase of the sound signal input to first speaker 51 and the phase of the sound signal input to second speaker 52 are opposite. The term “opposite (phase)” is intended to include any other cases than the case in which the phase difference is exactly 180 degrees. In other words, the phase of the sound signal input to first speaker 51 may be referred to as being opposite to the phase of the sound signal input to second speaker 52 even when the phase difference between the phase of the sound signal input to first speaker 51 and the phase of the sound signal input to second speaker 52 deviates from 180 degrees to an extent. In addition, phase controller 30 may control the phase of the at least one sound signal depending on the speed of vehicle 200.

First amplifier 41 is connected between phase controller 30 and first speaker 51. First amplifier 41 amplifies the sound signal output from sound source 20 at a predetermined degree of amplification and output it to first speaker 51.

Second amplifier 42 is connected between phase controller 30 and second speaker 52. Second amplifier 42 amplifies the signal output from sound source 20 at a predetermined degree of amplification and output it to second speaker 52. The amplification at this time may be the same as the amplification of first amplifier 41 or may be different from the amplification of first amplifier 41.

First amplifier 41 and second amplifier 42 may each be an analog amplifier or a digital amplifier.

First speaker 51 and second speaker 52 output notification sounds notifying the approach of vehicle 200 to the outside. First speaker 51 and second speaker 52 function to convert electric signals into mechanical vibrations and output notification sounds at sound pressures based on the electric signals. First speaker 51 and second speaker 52 output sounds corresponding to the sound signals output from sound source 20. The phase of at least one sound signal out of the sound signal input to first speaker 51 and the sound signal input to second speaker 52 is controlled by phase controller 30. First speaker 51 and second speaker 52 are provided (one-packaged) in one speaker case 53. If first speaker 51 and second speaker 52 are not provided in one speaker case 53 and are spaced apart, notification sounds from first speaker 51 and second speaker 52 may be cancelled out or sound pressures may interfere constructively in unexpected positions depending on the distance between the speakers. In contrast, since first speaker 51 and second speaker 52 are provided in one speaker case 53, it is possible to prevent the notification sounds from the speakers from being cancelled out or prevent the sound pressures from interfering constructively in unexpected positions. Further, since first speaker 51 and second speaker 52 are provided in one speaker case 53, cost reduction can be achieved because, for example, first speaker 51 and second speaker 52 can be attached to vehicle 200 at one time.

Rotator 60 rotates (for example, pivots) first speaker 51 and second speaker 52. For example, rotator 60 is implemented by a motor or the like.

Information processor 10 is implemented by a microcontroller, for example. The microcontroller is a semiconductor integrated circuit or the like including a ROM (Read Only Memory) and a RAM (Random Access Memory), which store a program, a processor (CPU: Central Processing Unit) that executes the program, and the like. For example, information processor 10 functions to acquire the speed of vehicle 200 from, for example, an ECU (Electronic Control Unit). For example, in information processor 10, the processor executes the program to prevent sound source 20 from outputting a sound signal when the speed of vehicle 200 is equal to or larger than a predetermined speed, to cause phase controller 30 to control the phase of at least one sound signal (for example, to control the phase of at least one sound signal depending on the speed of vehicle 200), and to cause rotator 60 to rotate first speaker 51 and second speaker 52.

For example, while vehicle 200 is stopped, information processor 10 may prevent phase controller 30 from controlling the phase of at least one sound signal so that the phase of the sound signal input to first speaker 51 and the phase of the sound signal input to second speaker 52 are in phase. For example, as the speed of vehicle 200 increases, information processor 10 may bring the phase of the sound signal input to first speaker 51 and the phase of the sound signal input to second speaker 52 closer to opposite phases. For example, when the speed of vehicle 200 reaches a predetermined speed (for example, 40 km/h) or larger, information processor 10 may then prevent sound source 20 from outputting a sound signal so that no sound is output from first speaker 51 nor second speaker 52. Alternatively, when the speed of vehicle 200 is equal to or larger than a predetermined speed, information processor 10 may prevent first amplifier 41 and second amplifier 42 from amplifying sound signals so that no sound is output from first speaker 51 nor second speaker 52.

For example, it is possible to control directivity of notification sounds output from at least two speakers by providing phase difference between the sounds output from the at least two speakers. Accordingly, it is possible to control phases of sound signals input to first speaker 51 and second speaker 52 provided in one speaker case 53, so that sound pressures to the left and right of vehicle 200 can be made higher than the sound pressure along a longitudinal axis of the vehicle. In other words, while vehicle 200 is running, the sound pressures of the notification sounds to the left and right of the vehicle can be made higher and the sound pressure of the notification sound leaking into the vehicle cabin located along the longitudinal axis of vehicle 200 can be made lower. In this way, it is possible to effectively output the notification sound to the outside of the vehicle while reducing uncomfortableness to passengers.

Next, a specific example of ambient sound pressures when notification sounds are output from speaker system 50.

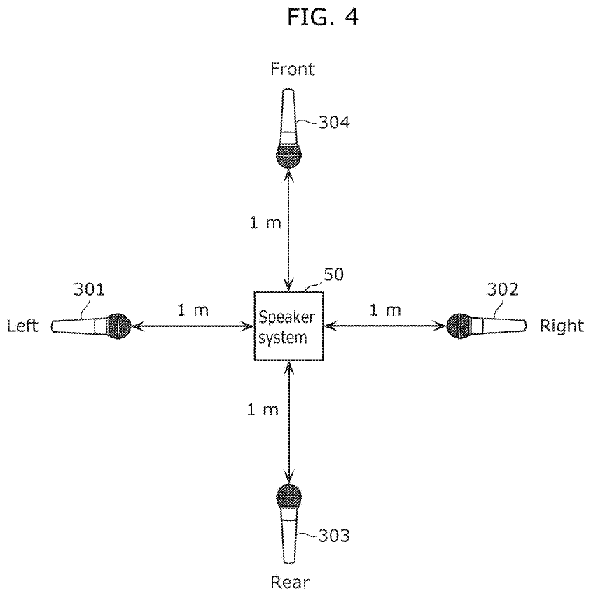

FIG. 4 illustrates a positional relationship between speaker system 50 and microphones.

As illustrated in FIG. 4, microphone 301 is disposed at 1 m away from speaker system 50 to the left, microphone 302 is disposed at 1 m away from speaker system 50 to the right, microphone 303 is disposed at 1 m forward from speaker system 50, and microphone 304 is disposed at 1 m backward from speaker system 50. For example, since speaker system 50 is disposed in the hood portion of vehicle 200, the place where microphone 304 behind speaker system 50 is located corresponds to the inside of the vehicle cabin. Similarly, the place where microphone 303 in front of speaker system 50 is located corresponds to the front of the vehicle, the place where microphone 301 to the left of speaker system 50 is located corresponds to the left of the vehicle, and the place where microphone 302 to the right of speaker system 50 is located corresponds to the right of the vehicle.

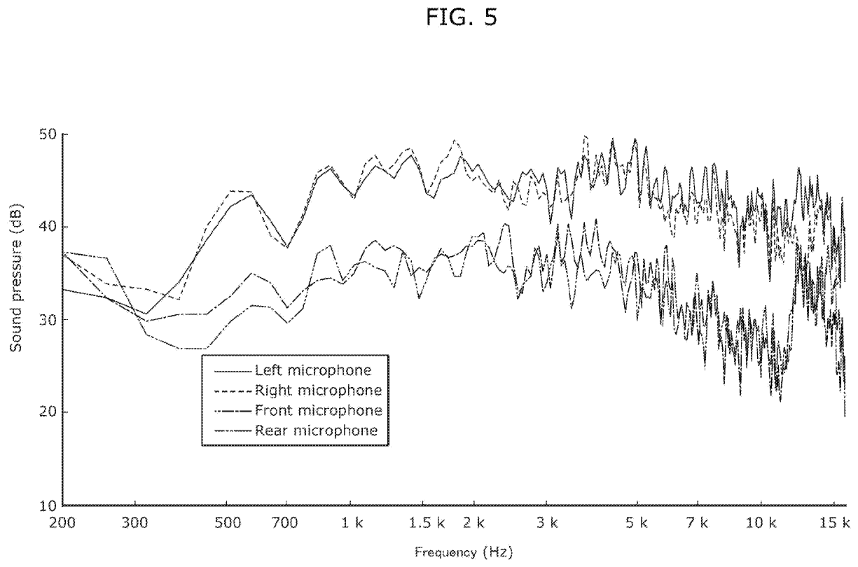

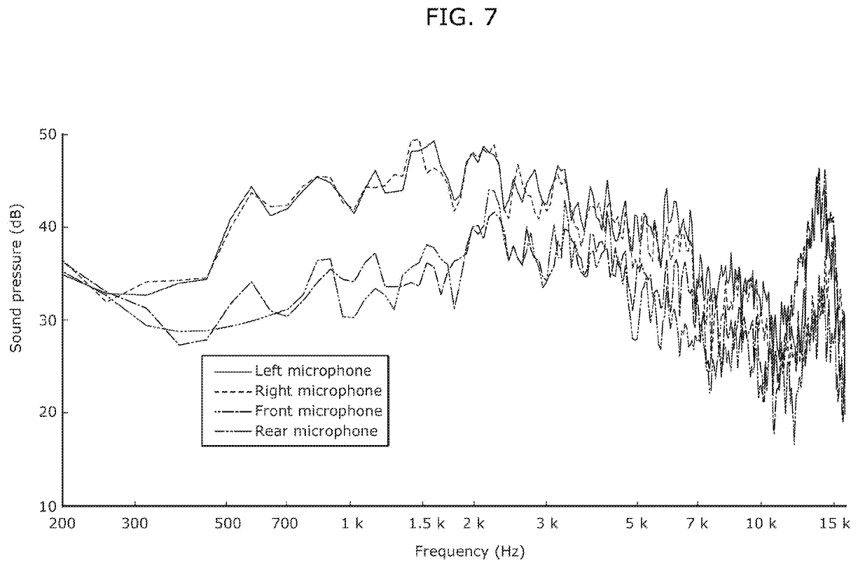

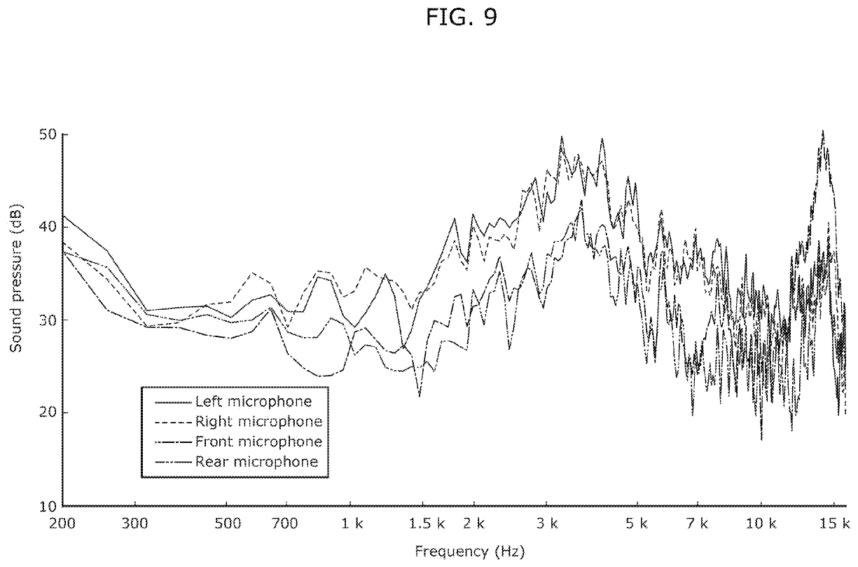

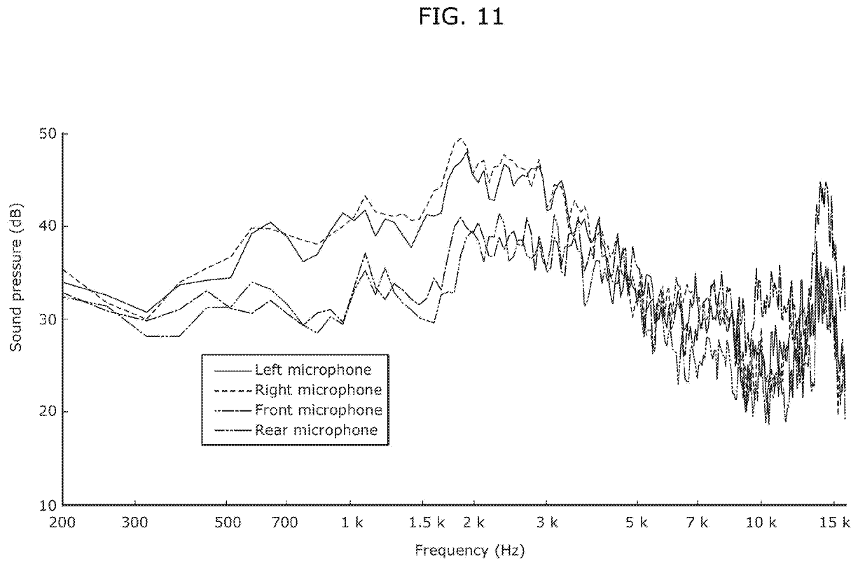

FIG. 5 is a graph illustrating frequency characteristics of sound pressures of sounds output from first speaker 51 and second speaker 52 disposed back-to-back as illustrated in FIG. 2. Note that the phase of the sound signal input to first speaker 51 and the phase of the sound signal input to second speaker 52 are opposite. In FIG. 5, a solid line indicates frequency characteristics of a sound pressure of a sound collected by microphone 301, a dashed line indicates frequency characteristics of a sound pressure of a sound collected by microphone 302, a long dashed short-dashed line indicates frequency characteristics of a sound pressure of a sound collected by microphone 303, and a long dashed double-short-dashed line indicates frequency characteristics of a sound pressure of a sound collected by microphone 304. In FIG. 7, FIG. 9, and FIG. 11, the association between the types of line and microphones is the same.

As illustrated in FIG. 5, with first speaker 51 and second speaker 52 being disposed back-to-back, it can be seen that the sound pressures of the sounds collected by microphones 301 and 302 (i.e. the sound pressures of notification sounds to the left and right of vehicle 200) can be increased and the sound pressure of the sound collected by microphone 304 (i.e. the sound pressure of the notification sound leaking into the vehicle cabin) can be decreased in the frequency band of approximately 300 Hz to approximately 12 kHz. In this way, it is possible to effectively output the notification sound to the outside of the vehicle while reducing uncomfortableness to passengers.

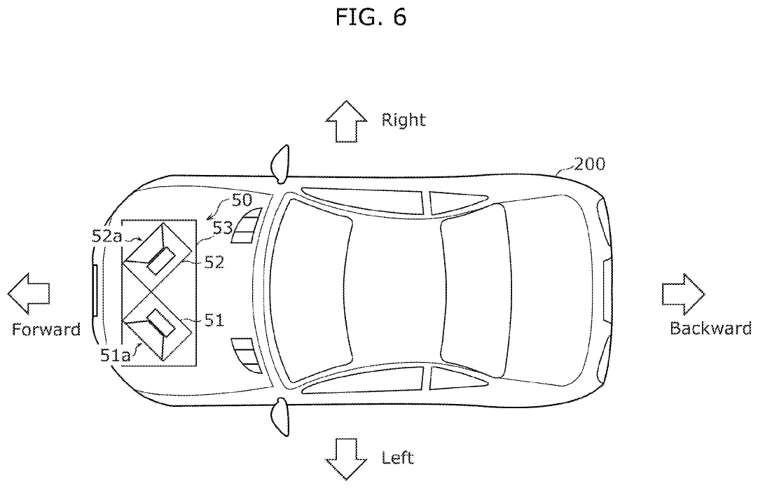

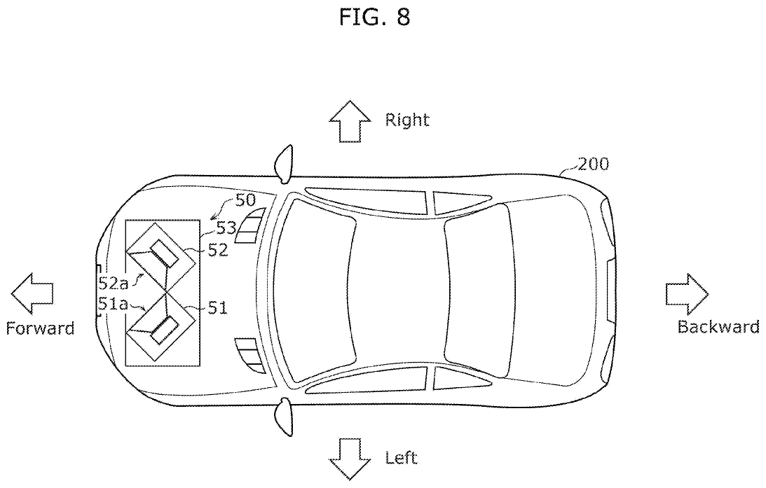

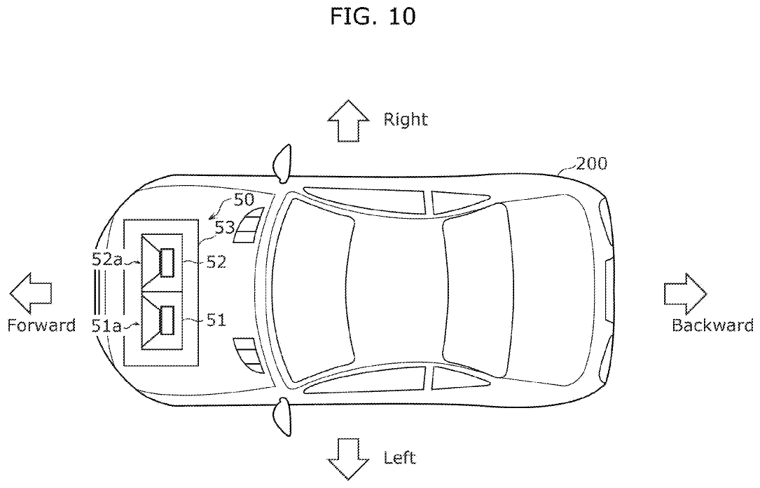

Alternatively, first speaker 51 and second speaker 52 need not to be disposed back-to-back. For example, the arrangement may be as illustrated in FIG. 6, FIG. 8, or FIG. 10.

FIG. 6 illustrates an example of vehicle 200 equipped with speaker system 50 including first speaker 51, baffle face 51a of which is oriented to the front left of vehicle 200, and second speaker 52, baffle face 52a of which is oriented to the front right of vehicle 200, in vehicle approach notification system 100 according to the embodiment.

As illustrated in FIG. 6, first speaker 51 is disposed closer to the left side of vehicle 200 than second speaker 52, and first speaker 51 and second speaker 52 may be disposed such that baffle face 51a of first speaker 51 is oriented to the front left of vehicle 200 and baffle face 52a of second speaker 52 is oriented to the front right of vehicle 200. For example, the angle formed between baffle face 51a of first speaker 51 and baffle face 52a of second speaker 52 may be substantially 90 degrees. Note that substantially 90 degrees may be from 80 to 100 degrees.

FIG. 7 is a graph illustrating frequency characteristics of sound pressures of sounds output from first speaker 51, baffle face 51a of which is oriented to the front left of vehicle 200, and second speaker 52, baffle face 52a of which is oriented to the front right of vehicle 200 as illustrated in FIG. 6. Note that the phase of the sound signal input to first speaker 51 and the phase of the sound signal input to second speaker 52 are opposite.

As illustrated in FIG. 7, with first speaker 51 and second speaker 52 being disposed such that baffle face 51a of first speaker 51 is oriented to the front left of vehicle 200 and baffle face 52a of second speaker 52 is oriented to the front right of vehicle 200, it can be seen that the sound pressures of the sounds collected by microphones 301 and 302 (i.e. the sound pressures of the notification sounds to the left and right of vehicle 200) can be increased and the sound pressure of the sound collected by microphone 304 (i.e. the sound pressure of the notification sound leaking into the vehicle cabin) can be decreased in the frequency band of approximately 300 Hz to approximately 3 kHz or lower. In this way, it is possible to effectively output the notification sound to the outside of the vehicle while reducing uncomfortableness to passengers.

FIG. 8 illustrates an example of vehicle 200 equipped with speaker system 50 including first speaker 51, baffle face 51a of which is oriented to the front right of vehicle 200, and second speaker 52, baffle face 52a of which is oriented to the front left of vehicle 200, in vehicle approach notification system 100 according to the embodiment.

As illustrated in FIG. 8, first speaker 51 is disposed closer to the left side of vehicle 200 than second speaker 52, and first speaker 51 and second speaker 52 may be disposed such that baffle face 51a of first speaker 51 is oriented to the front right of vehicle 200 and baffle face 52a of second speaker 52 is oriented to the front left of vehicle 200. For example, the angle formed between baffle face 51a of first speaker 51 and baffle face 52a of second speaker 52 may be substantially 90 degrees. Note that substantially 90 degrees may be from 80 to 100 degrees.

FIG. 9 is a graph illustrating frequency characteristics of sound pressures of sounds output from first speaker 51, baffle face 51a of which is oriented to the front right of vehicle 200, and second speaker 52, baffle face 52a of which is oriented to the front left of vehicle 200 as illustrated in FIG. 8. Note that the phase of the sound signal input to first speaker 51 and the phase of the sound signal input to second speaker 52 are opposite.

As illustrated in FIG. 9, with first speaker 51 and second speaker 52 being disposed such that baffle face 51a of first speaker 51 is oriented to the front right of vehicle 200 and baffle face 52a of second speaker 52 is oriented to the front left of vehicle 200, it can be seen that the sound pressures of the sounds collected by microphones 301 and 302 (i.e. the sound pressures of the notification sounds to the left and right of vehicle 200) can be increased and the sound pressure of the sound collected by microphone 304 (i.e. the sound pressure of the notification sound leaking into the vehicle cabin) can be decreased in the frequency band of approximately 1.5 kHz to approximately 5 kHz or lower. In this way, it is possible to effectively output the notification sound to the outside of the vehicle while reducing uncomfortableness to passengers.

FIG. 10 illustrates an example of vehicle 200 equipped with speaker system 50 including first speaker 51 and second speaker 52, both of which have baffle faces 51a and 52a oriented forward vehicle 200, in vehicle approach notification system 100 according to the embodiment.

As illustrated in FIG. 10, first speaker 51 and second speaker 52 may be disposed such that baffle faces 51a and 52a are both oriented forward vehicle 200.

FIG. 11 is a graph illustrating frequency characteristics of sound pressures of sounds output from first speaker 51 and second speaker 52, both of which have baffle faces 51a and 52a oriented forward vehicle 200 as illustrated in FIG. 10. Note that the phase of the sound signal input to first speaker 51 and the phase of the sound signal input to second speaker 52 are opposite.

As illustrated in FIG. 11, with first speaker 51 and second speaker 52 being disposed such that baffle faces 51a and 52a are both oriented forward vehicle 200, it can be seen that the sound pressures of the sounds collected by microphones 301 and 302 (i.e. the sound pressures of the notification sounds to the left and right of vehicle 200) can be increased and the sound pressure of the sound collected by microphone 304 (i.e. the sound pressure of the notification sound leaking into the vehicle cabin) can be decreased in the frequency band of approximately 300 Hz to approximately 3 kHz or lower. In this way, it is possible to effectively output the notification sound to the outside of the vehicle while reducing uncomfortableness to passengers.

Although not illustrated, first speaker 51 and second speaker 52 may be disposed such that baffle faces 51a and 52a are both oriented backward vehicle 200. In this case, in FIG. 11, the solid line indicates frequency characteristics of the sound pressure of the sound collected by microphone 301, the dashed line indicates frequency characteristics of the sound pressure of the sound collected by microphone 302, the long dashed short-dashed line indicates frequency characteristics of the sound pressure of the sound collected by microphone 304, and the long dashed double-short-dashed line indicates frequency characteristics of the sound pressure of the sound collected by microphone 303. In other words, with first speaker 51 and second speaker 52 being disposed such that baffle faces 51a and 52a are both oriented backward vehicle 200, the sound pressures of the sounds collected by microphones 301 and 302 (i.e. the sound pressures of the notification sounds to the left and right of vehicle 200) can be increased and the sound pressure of the sound collected by microphone 303 (i.e. the sound pressure of the notification sound leaking into the vehicle cabin) can be decreased in the frequency band of approximately 300 Hz to approximately 3 kHz or lower. In this way, it is possible to effectively output the notification sound to the outside of the vehicle while reducing uncomfortableness to passengers.

### Other Embodiments

Although vehicle approach notification system 100 and vehicle 200 including vehicle approach notification system 100 according to one or more aspects have been described above based on an exemplary embodiment, the present disclosure is not limited to the above-described embodiment. Forms realized by various modifications to the above-described embodiment that can be conceived by those skilled in the art without departing from the essence of the disclosure, as well as forms realized by combining structural components of different embodiments may be included in the scope of the present disclosure.

For example, in the embodiment described above, although description has been made as to an example of speaker system 50 installed behind the license plate in the hood portion of vehicle 200, this is not a limitation. For example, speaker system 50 may be disposed near the license plate in the rear of vehicle.

For example, in the embodiment described above, although description has been made as to an example of vehicle approach notification system 100 including rotator 60, rotator 60 needs not to be provided. In this case, the orientation of each of first speaker 51 and second speaker 52 may be changed manually.

The present disclosure may be implemented as not only vehicle approach notification system 100 but also vehicle approach notification method that includes steps (processes) performed by components constituting vehicle approach notification system 100.

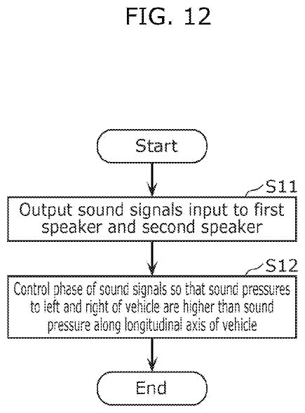

FIG. 12 is a flowchart illustrating an example of a vehicle approach notification method according to another embodiment.

The vehicle approach notification method is a vehicle approach notification method for notifying approach of a vehicle. The vehicle approach notification method includes the processes of outputting sound signals which are respectively input to a first speaker and a second speaker provided in a speaker case included in a vehicle, the sound signals corresponding to a sound notifying the approach of the vehicle (step S11) and controlling a phase of at least one sound signal out of the sound signal input to the first speaker and the sound signal input to the second speaker so that sound pressures to the left and right of the vehicle are higher than a sound pressure along a longitudinal axis of the vehicle, the sound pressures being caused by sounds output from the first speaker and the second speaker (step S12).

For example, the steps in the vehicle approach notification method may be executed by a computer (computer system). In addition, the present disclosure can be realized as a program for causing the computer to execute the steps included in the vehicle approach notification system.

Furthermore, the present disclosure can be realized as a non-transitory computer-readable recording medium, such as a CD-ROM, on which the program is recorded.

For example, when the present disclosure is implemented as a program (software), the respective steps are executed by way of the program being executed using hardware resources of the computer such as a CPU, memory, and input/output circuit, etc. Specifically, the respective steps are executed by way of a CPU reading out data from a memory or an input/output circuit, etc., and performing arithmetic operations on the data, then outputting the result of the arithmetic operations to the memory or the input/output unit.

Furthermore, each of the elements of vehicle approach notification system 100 according to the exemplary embodiments may be implemented as a dedicated or general-purpose circuit.

Furthermore, each of the elements of vehicle approach notification system 100 according to the exemplary embodiments may be implemented as a large-scale integration (LSI) which is an integrated circuit (IC).

Furthermore, the integrated circuit is not limited to an LSI, and may be realized by a dedicated or general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed

In addition, when a circuit integration technology that replaces LSIs comes along owing to advances of the semiconductor technology or to a separate derivative technology, the elements included in vehicle approach notification system 100 should be understandably integrated using that technology.

While various embodiments have been described herein above, it is to be appreciated that various changes in form and detail may be made without departing from the spirit and scope of the present disclosure as presently or hereafter claimed.

Further Information about Technical Background to this Application

The disclosure of the following Japanese Patent Application including specification, drawings and claims is incorporated herein by reference in its entirety: Japanese Patent Application No. 2020-055537 filed on Mar. 26, 2020.

### INDUSTRIAL APPLICABILITY

The present disclosure may be applicable to a vehicle approach notification system provided in noiseless vehicles such as electric vehicles and hybrid vehicles.

1. A vehicle approach notification system for notifying approach of a vehicle, the vehicle approach notification system comprising:
a first speaker and a second speaker provided in a speaker case included in a vehicle;
a sound source that outputs sound signals which are respectively input to the first speaker and the second speaker and correspond to sounds notifying the approach of the vehicle; and
a phase controller that controls a phase of at least one sound signal out of the sound signal input to the first speaker and the sound signal input to the second speaker so that sound pressure at left and right of the vehicle caused by the sounds output from the first speaker and the second speaker is higher than sound pressure along a longitudinal axis of the vehicle caused by the sounds output from the first speaker and the second speaker.

2. The vehicle approach notification system according to claim 1, wherein
the first speaker and the second speaker are disposed back-to-back so that a baffle face of the first speaker is oriented to the left of the vehicle and a baffle face of the second speaker is oriented to the right of the vehicle.

3. The vehicle approach notification system according to claim 1, wherein
the first speaker is disposed closer to a left side of the vehicle than the second speaker is, and
the first speaker and the second speaker are disposed so that a baffle face of the first speaker is oriented to a front left of the vehicle and a baffle face of the second speaker is oriented to a front right of the vehicle.

4. The vehicle approach notification system according to claim 1, wherein
the first speaker is disposed closer to a left side of the vehicle than the second speaker is, and
the first speaker and the second speaker are disposed so that a baffle face of the first speaker is oriented to a front right of the vehicle and a baffle face of the second speaker is oriented to a front left of the vehicle.

5. The vehicle approach notification system according to claim 3, wherein
the baffle face of the first speaker and the baffle face of the second speaker form an angle of approximately 90 degrees.

6. The vehicle approach notification system according to claim 4, wherein
the baffle face of the first speaker and the baffle face of the second speaker form an angle of approximately 90 degrees.

7. The vehicle approach notification system according to claim 1, wherein
the first speaker and the second speaker are disposed so that a baffle face of the first speaker and a baffle face or the second speaker are both oriented to a front or a back of the vehicle.

8. The vehicle approach notification system according to claim 1, further comprising:
a rotator that rotates the first speaker and the second speaker.

9. The vehicle approach notification system according to claim 1, wherein
the phase controller controls the phase of the at least one signal such that a phase of the sound signal input to the first speaker and a phase of the sound signal input to the second speaker are opposite phases.

10. The vehicle approach notification system according to claim 1, wherein
the phase controller controls the phase of the at least one sound signal according to a speed of the vehicle.

11. The vehicle approach notification system according to claim 1, wherein
no sound is output from the first speaker and the second speaker when a speed of the vehicle is at least a predetermined speed.

12. A vehicle, comprising:
the vehicle approach notification system according to claim 1.

13. A vehicle approach notification method for notifying approach of a vehicle, the vehicle approach notification method comprising:
outputting sound signals which are respectively input to a first speaker and a second speaker provided in a speaker case included in a vehicle, the sound signals corresponding to a sound notifying the approach of the vehicle; and
controlling a phase of at least one sound signal out of the sound signal input to the first speaker and the sound signal input to the second speaker so that sound pressure at left and right of the vehicle caused by the sounds output from the first speaker and the second speaker is higher than sound pressure along a longitudinal axis of the vehicle caused by the sounds output from the first speaker and the second speaker.
